(19) United States
(12) Patent Application Publication
(10) Pub. No.: US 2021/0400580 A1
(43) Pub. Date: Dec. 23, 2021

(54) POWER-EFFICIENT CONFIGURATION OF TIME OFFSET VALUES

(71) Applicant: Telefonaktiebolaget LM Ericsson (publ), Stockholm (SE)

(72) Inventors: Sina MALEKI, Malmö (SE); Ali NADER, Malmö (SE); Andres REIAL, Lomma (SE); Gang ZOU, Lund (SE)

(21) Appl. No.: 17/289,989

(22) PCT Filed: Nov. 1, 2019
(86) PCT No.: PCT/EP2019/079993

§ 371 Date: Apr. 29, 2021

Related U.S. Application Data
(60) Provisional application No. 62/754,708, filed on Nov. 2, 2018.

(51) Int. Cl. H04W 52/02

(52) U.S. Cl. CPC H04W 52/0229; H04W 52/0216

(57) ABSTRACT

A method, system and apparatus are disclosed. In one or more embodiments, a network node configured to communicate with a wireless device (WD) is provided. The network node configured to, and/or including a radio interface and/or including processing circuitry configured to: optionally receive information associated with implementing a time offset at the wireless device, determine at least one time offset between a physical control channel and a physical shared channel where the at least one time offset configured to allow the wireless device to perform at least one power saving action during at least a portion of a duration of the at least one time offset, and optionally indicate the at least one time offset to the wireless device.

### FIELD

The present disclosure relates to wireless communications, and in particular, to time offsets to allow a wireless device to perform at least one power saving action.

### BACKGROUND

Radio Resource Control (RRC) includes several states or modes. One activity in RRC_CONNECTED mode is monitoring the Physical Downlink Control Channel (PDCCH) for scheduled Physical Downlink Shared Channel (PDSCH)/Physical Uplink Shared Channel (PUSCH) transmissions. An example of a radio resource is shown in FIG. 1.

The wireless device may decode all PDCCH occasions/Time/Frequency (TF) locations/configurations according to a search space. After decoding according to each blind decoding (BD) option, the wireless device can check whether the PDCCH was meant for or directed to the wireless device, based on checking the Cyclic Redundancy Check (CRC) using its cell-Radio Network Temporary Identifier (c-RNTI).

Further, the PDCCH also informs the wireless device about the scheduling time offset values K0, K1, K2 and periodic triggering offset (aperiodicTriggeringOffset parameter) between the PDCCH and PxSCH and Channel State Information-Reference Signals (CSI-RS) reception. In summary, K0, K1 and K2 can adopt values 0, 1, 2, . . . which correspond to the number of slot offset between the PDCCH and PDSCH, or PUCCH/PUSCH respectively. While K0 is related to scheduling DL PDSCH, K1 is related to HARQ ACK/NACK operations, and K2 corresponds to the offset between PDCCH and PUCCH/PUSCH in the UL.

On the other hand, aperiodicTriggeringOffset corresponds to the offset until CSI-RS reception, which can change in the range 0, 1, 2, 3, 4.

Unlike LTE, in NR the scheduling offsets can be larger than zero. This gives the opportunity of cross-slot scheduling to the network in addition to the self-slot scheduling. It has been considered to use the opportunity of cross-slot scheduling for power savings in the wireless device by adaptively changing the bandwidth part (BWP) between lower and upper ones, e.g. for PDCCH and PDSCH to reduce the power consumption.

Other wireless power savings-related systems are now described.

### NR Description

The new radio (NR) standard of the Third Generation Partnership Project (3GPP) is being designed to provide service for multiple use cases such as enhanced mobile broadband (eMBB), ultra-reliable and low latency communication (URLLC), and machine type communication (MTC). Each of these services has different technical requirements. For example, the general characteristic for eMBB is high data rate with moderate latency and moderate coverage, while URLLC service may require a low latency and high reliability transmission but perhaps for moderate data rates.

One of the solutions for low latency data transmission is shorter transmission time intervals. In NR, in addition to transmission in a slot, a mini-slot transmission is also allowed to reduce latency. A mini-slot may consist of any number of 1 to 14 Orthogonal Frequency-Division Multiplexing (OFDM) symbols. It should be noted that the concepts of slot and mini-slot are not specific to a specific service, meaning that a mini-slot may be used for either eMBB, URLLC, or other services.

### Wireless Device Power Consumption Description

In general, significant power can be spent on monitoring the PDCCH in Long Term Evolution (LTE) based on one Discontinuous Reception (DRX) setting from LTE field logs. The situation can be similar in NR if similar DRX setting with traffic modeling is utilized, as the wireless device may need to perform blind detection in its configured control resource sets (CORESETs) to identify whether there is a PDCCH sent to the wireless device, and act accordingly.

### NR Numerology

3GPP is defining technical specifications for New Radio (NR) (also known as 5G). In 3GPP release 15 (Rel-15) NR, a wireless device can be configured with up to four carrier bandwidth parts (BWPs) in the downlink with a single downlink carrier bandwidth part being active at a given time. A wireless device can be configured with up to four carrier bandwidth parts in the uplink with a single uplink carrier bandwidth part being active at a given time. If a wireless device is configured with a supplementary uplink, the wireless device can additionally be configured with up to four carrier bandwidth parts in the supplementary uplink with a single supplementary uplink carrier bandwidth part being active at a given time.

For a carrier bandwidth part with a given numerology μᵢ, a contiguous set of physical resource blocks (PRBs) are defined and numbered from 0 to N_{BWPi,}^{size}−1, where i is the index of the carrier bandwidth part. A resource block (RB) is defined as 12 consecutive subcarriers in the frequency domain.

### Numerologies:

Multiple orthogonal frequency-division multiplexing (OFDM) numerologies, μ, are supported in NR as shown in Table 1, where the subcarrier spacing, Δf, and the cyclic prefix for a carrier bandwidth part are configured by different higher layer parameters for downlink (DL) and uplink (UL), respectively.

TABLE 1

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

### Physical Channels:

A downlink physical channel corresponds to a set of resource elements carrying information originating from higher layers. The following example downlink physical channels are defined:

Physical Downlink Shared Channel, PDSCH

Physical Broadcast Channel, PBCH

Physical Downlink Control Channel, PDCCH:

PDSCH is a physical channel used for unicast downlink data transmission, and also for transmission of RAR (random access response), certain system information blocks, and paging information. PBCH carries the basic system information, that may be required by the wireless device to access the network. PDCCH is used for transmitting downlink control information (DCI), mainly scheduling decisions, required for reception of PDSCH, and for uplink scheduling grants enabling transmission on PUSCH.

An uplink physical channel corresponds to a set of resource elements carrying information originating from higher layers. The following uplink physical channel examples include:

Physical Uplink Shared Channel, PUSCH:

Physical Uplink Control Channel, PUCCH

Physical Random Access Channel, PRACH description

PUSCH is the uplink counterpart to the PDSCH. PUCCH is used by wireless devices to transmit uplink control information, including HARQ acknowledgments, channel state information reports, etc. PRACH is used for random access preamble transmission.

Example contents of a DL DCI 1-0 is shown below.

Example contents of a DCI format 1_0 with CRC scrambled by C-RNTI/CS_RNTI:
Identifier for DCI formats—1 bits
   The value of this bit field may always be set to 1, indicating a DL DCI format
Frequency domain resource assignment −┌log₂(N_{RB}^{DL,BWP}(N_{RB}^{DL,BWP}+1)/2)┘ bits
   N_{RB}^{DL,BWP} is the size of the active DL bandwidth part in case DCI format 1_0 is monitored in the wireless device specific search space
      the total number of different DCI sizes configured to monitor is no more than 4 for the cell, and
      the total number of different DCI sizes with C-RNTI configured to be monitor is no more than 3 for the cell,
   otherwise, N_{RB}^{DL,BWP} is the size of CORESET 0.
Time domain resource assignment—4 bits as defined in Subclause 5.1.2.1 of 3GPP Technical Specification (TS) 38.214,
VRB-to-PRB mapping—1 bit according to Table 7.3.1.1.2-33 in 3GPP,
Modulation and coding scheme—5 bits as defined in Subclause 5.1.3 of 3GPP TS 38.214,
New data indicator—1 bit
Redundancy version—2 bits as defined in Table 7.3.1.1.1-2 in 3GPP
HARQ process number—4 bits
Downlink assignment index—2 bits as defined in Subclause 9.1.3 of 3GPP TS 38.213, as counter Downlink Assignment Index (DAI)
Transmit Power Control (TPC) command for scheduled PUCCH—2 bits as defined in Subclause 7.2.1 of 3GPP TS 38.213,
PUCCH resource indicator—3 bits as defined in Subclause 9.2.3 of 3GPP TS 38.213,
PDSCH-to-Hybrid Automatic Repeat Request (HARQ) feedback timing indicator—3 bits as defined in Subclause 9.2.3 of 3GPP TS 38.213.

### DRX Description

Referring back to DRX, DRX (Discontinuous reception): As shown in simplified DRX operation in FIG. 2, DRX allows the wireless device to transition to a lower power state where it may not be required to receive any transmission from the network node. There is an onDuration where the wireless device is awake and monitors for control channels, and if there is no control message detected by the wireless device, an Inactivity timer begins. The wireless device continues to monitor for the control channel until a valid control message addressed to the wireless device is received or the inactivity timer expires. If the wireless device receives a valid control message, it extends the inactivity timer and continues to monitor the PDCCH. If the inactivity timer expires, then the wireless device can stop receiving transmissions from the network node (e.g. stop control channel monitoring) until end of the DRX cycle. Typically, the DRX parameters are configured by RRC and there are some other DRX parameters including Round-Trip Time (RTT) related, HARQ related, etc. On duration and the time duration when inactivity timer is running may generally be referred to as active time.

The following terms used above and defined below are typically associated with DRX operation:

Active Time: Time related to DRX operation, during which the MAC entity monitors the PDCCH.

DRX Cycle: Specifies the periodic repetition of the On Duration followed by a possible period of inactivity as illustrated in FIG. 2.

Inactivity Timer: Generally, refers to the number of consecutive PDCCH-subframe(s)/slots after the subframe/slot in which a PDCCH indicates an initial UL, DL or SL user data transmission for a MAC entity.

MAC entity is the medium access control entity, and there is one MAC entity per configured cell group, for example the master cell group and secondary cell group.

One aspect of DRX is that DRX functionality is configured by RRC, which is typically operating on a slower scale than MAC or Physical layer. Thus, the DRX parameter settings, etc. may not be quickly adaptable through RRC configuration, especially if the wireless device has a mix of traffic types.

### SUMMARY

Some embodiments advantageously provide methods, systems, network nodes and wireless devices for providing time offsets to allow a wireless device to perform at least one power saving action. Therefore, providing a power-efficient configuration of time offset values.

In particular, the disclosure provides methods and techniques for the network node and the wireless device (benefitting from specific offsets) to be configured by specific offset values during all/certain occasions.

Aspects of the invention are defined by the independent claims, and embodiments thereof are defined by the dependent claims.

One or more of the following methods may be used in which a set of offsets are configured through the RRC and specific predictable subsets or values thereof may be activated either at all times, or certain occasions (e.g., during DRX operation) either implicitly or explicitly via RRC and/or MAC(CE) and/or DCI.
1. The wireless device indicates to the network node that it is beneficial for the wireless device to be configured with higher offset values for certain/all BWPs. This indication can either be explicitly coupled to the offsets, or a generic indication, e.g., delay-tolerant UE, non-mission-critical, benefits-from-power-saving, etc.
2. A wireless device proposes specific minimum threshold (or thresholds per BWP) for the offsets values below which the wireless device prefers not be scheduled. Such a threshold may be applicable to certain occasions only, e.g., first PDCCH that requests the wireless device to perform an action during a certain time (during the On-Duration of C-DRX threshold). The preferred thresholds may be expressed in terms of, e.g., absolute offset values or masks to the set of possible offsets currently configured by the network node for various occasions and/or BWPs.
3. The network node may consider the wireless device preference signaling and provide additional configuration information to the wireless device regarding the minimum offset that the wireless device may assume, which may be wireless device-specific. The configured minimum limits may be expressed in terms of, e.g., absolute offset values or masks to the set of possible offsets currently configured by the network node for various occasions and/or BWPs. Thus, based on any of the implicit or explicit preferences provided by the wireless device, the network node may choose to accept/configure the wireless device with offsets that are beneficial to the wireless device, and of which the wireless device is aware of during its operation.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of an exemplary radio resource in NR;

FIG. 2 is diagram of an example DRX;

FIG. 3 is a schematic diagram of an exemplary network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating exemplary methods implemented in a communication system including a host computer, a network node and a wireless device for executing a client application at a wireless device according to some embodiments of the present disclosure;

FIG. 6 is a flowchart illustrating exemplary methods implemented in a communication system including a host computer, a network node and a wireless device for receiving user data at a wireless device according to some embodiments of the present disclosure;

FIG. 7 is a flowchart illustrating exemplary methods implemented in a communication system including a host computer, a network node and a wireless device for receiving user data from the wireless device at a host computer according to some embodiments of the present disclosure;

FIG. 8 is a flowchart illustrating exemplary methods implemented in a communication system including a host computer, a network node and a wireless device for receiving user data at a host computer according to some embodiments of the present disclosure;

FIG. 9 is a flowchart of an exemplary process in a network node according to some embodiments of the present disclosure;

FIG. 10 is a flowchart of an exemplary process in a wireless device according to some embodiments of the present disclosure;

FIG. 11 is a diagram of an example implementation of a first method in accordance with the principles of the disclosure;

FIG. 12 is a diagram of configuring a wireless device with C-DRX threshold/mask according to second and third methods in accordance with the principles of the disclosure.

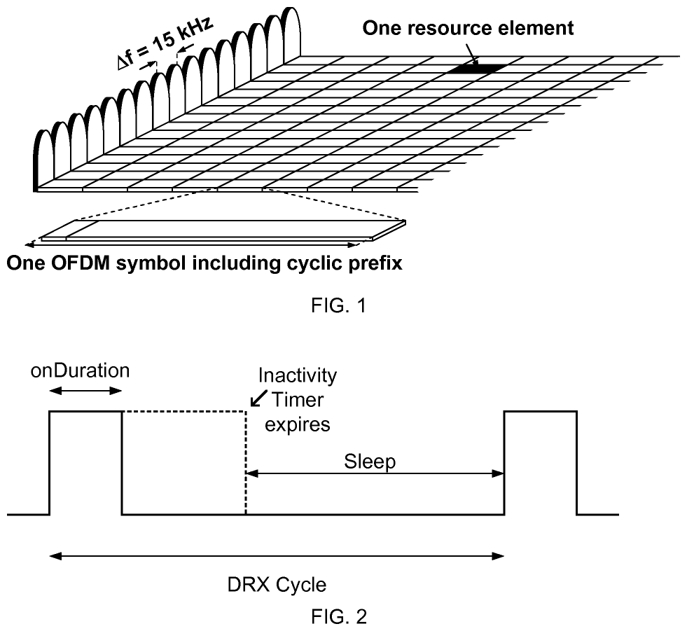

### DETAILED DESCRIPTION

Scheduling time offset values, i.e., K0, K1, K2, and aperiodicTriggeringOffset (parameter or field) can be used by the network and/or network node to inform the wireless device about upcoming activity, in time, between PDxCH and CSI-RS reception and/or PUSCH/PUCCH transmissions. However, even if the wireless device is aware of a potential set of values that may be used by the network node, the wireless device may not at any given point know what exact value out of the set will be used by the network node, e.g., about the exact K0 value (offset between PDCCH and PDSCH transmission) that will be used before having decoded the PDCCH. Indeed, the wireless device becomes aware of the exact value(s) after decoding the PDCCH, but may not have sufficient time to change its power operational mode, particularly if the set of K0 values configuration includes low offset value possibilities.

This problem may be particularly evident when, for example, trying to change the power mode of the wireless device between PDCCH and PDSCH/CSI-RS reception. For example, a wireless device may be able to potentially use a BWP with low bandwidth (BW) for PDCCH and a higher BW for PDSCH to save power, or simply modify the active BW setting based on the search space information, or, for example, a wireless device may be able to turn its reception chain off between PDCCH and PDSCH/CSI-R. However, to be able to perform such actions (e.g., adapting the BW/BWP, etc.), the wireless should be certain that K0>0 and aperiodicTriggeringOffset>0, otherwise the wireless device has to keep the radio frequency receiver at the wireless device at the full operational mode as there is a risk that the network node may use offset=0, which may not leave enough time for the wireless device to adapt the BWP or alternately turn off its receiver. Similar issues also exist for other offsets such as K1, K2.

Before describing in detail exemplary embodiments, it is noted that the embodiments reside primarily in combinations of apparatus components and processing steps related to time offsets for allowing a wireless device to perform at least one power saving action. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

An indication generally may explicitly and/or implicitly indicate the information it represents and/or indicates. Implicit indication may for example be based on position and/or resource used for transmission. Explicit indication may for example be based on a parametrization with one or more parameters, and/or one or more index or indices, and/or one or more bit patterns representing the information. It may in particular be considered that control signaling as described herein, based on the utilized resource sequence, implicitly indicates the control signaling type.

A channel may generally be a logical or physical channel. A channel may comprise and/or be arranged on one or more carriers, in particular a plurality of subcarriers. A wireless communication network may comprise at least one network node, in particular a network node as described herein. A terminal connected or communicating with a network may be considered to be connected or communicating with at least one network node, in particular any one of the network nodes described herein.

Configuring a terminal or wireless device or node may involve instructing and/or causing the wireless device or node to change its configuration, e.g., at least one setting and/or register entry and/or operational mode. A terminal or wireless device or node may be adapted to configure itself, e.g., according to information or data in a memory of the terminal or wireless device. Configuring a node or terminal or wireless device by another device or node or a network may refer to and/or comprise transmitting information and/or data and/or instructions to the wireless device or node by the other device or node or the network, e.g., allocation data (which may also be and/or comprise configuration data) and/or scheduling data and/or scheduling grants. Configuring a terminal may include sending allocation/configuration data to the terminal indicating which modulation and/or encoding to use. A terminal may be configured with and/or for scheduling data and/or to use, e.g., for transmission, scheduled and/or allocated uplink resources, and/or, e.g., for reception, scheduled and/or allocated downlink resources. Uplink resources and/or downlink resources may be scheduled and/or provided with allocation or configuration data.

Generally, configuring may include determining configuration data representing the configuration and providing, e.g. transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g. WD) may comprise scheduling downlink and/or uplink transmissions for the terminal, e.g. downlink data and/or downlink control signaling and/or DCI and/or uplink control or data or communication signaling, in particular acknowledgement signaling, and/or configuring resources and/or a resource pool therefor. In particular, configuring a terminal (e.g. WD) may comprise configuring the WD to perform certain measurements on certain subframes or radio resources and reporting such measurements according to embodiments of the present disclosure.

Even though the descriptions herein may be explained in the context of one of a Downlink (DL) and an Uplink (UL) communication, it should be understood that the basic principles disclosed may also be applicable to the other of the one of the DL and the UL communication. In some embodiments in this disclosure, the principles may be considered applicable to a transmitter and a receiver. For DL communication, the network node is the transmitter and the receiver is the WD. For the UL communication, the transmitter is the WD and the receiver is the network node.

The term “numerology” herein may comprise, e.g., any one or more of: frame duration, subframe or TTI duration, slot or minislot duration, symbol duration and the number of symbols per slot and subframe, subcarrier spacing, sampling frequency, Fast Fourier Transform (FFT) size, number of subcarriers per RB and RB bandwidth, number of RBs within a bandwidth, symbols per subframe, CP length, etc. The numerology determines the grid of REs in time and/or frequency domain.

In some embodiments, control information on one or more resources may be considered to be transmitted in a message having a specific format. A message may comprise or represent bits representing payload information and coding bits, e.g., for error coding.

Receiving (or obtaining) control information may comprise receiving one or more control information messages (e.g., an RRC monitoring parameter). It may be considered that receiving control signaling comprises demodulating and/or decoding and/or detecting, e.g. blind detection of, one or more messages, in particular a message carried by the control signaling, e.g. based on an assumed set of resources, which may be searched and/or listened for the control information. It may be assumed that both sides of the communication are aware of the configurations, and may determine the set of resources, e.g. based on the reference size.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

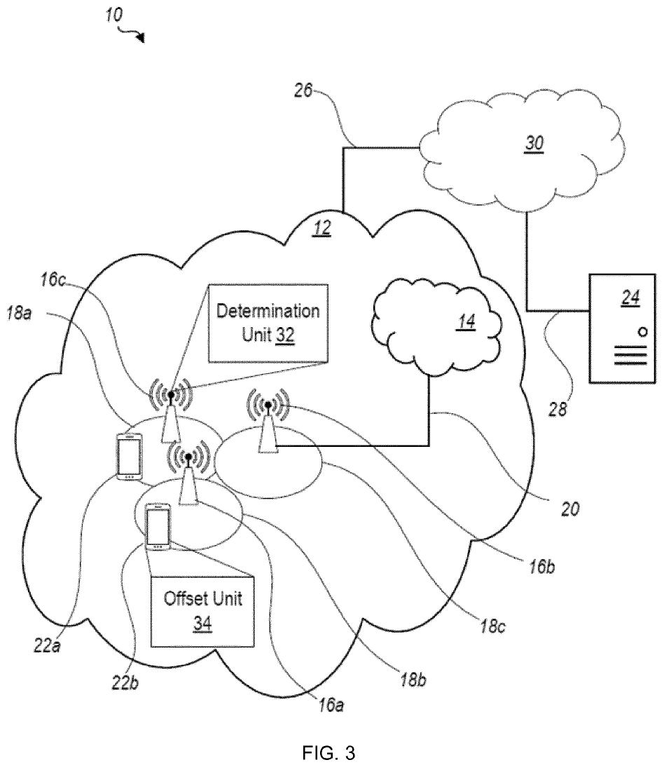

Embodiments provide time offsets to allow a wireless device to perform at least one power saving action. Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16c. A second WD 22b in coverage area 18b is wirelessly connectable to the corresponding network node 16a. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a determination unit 32 which is configured to determine time offsets to allow a wireless device to perform at least one power saving action. A wireless device 22 is configured to include an offset unit 34 which is configured to implement time offsets to allow a wireless device to perform at least one power saving action.

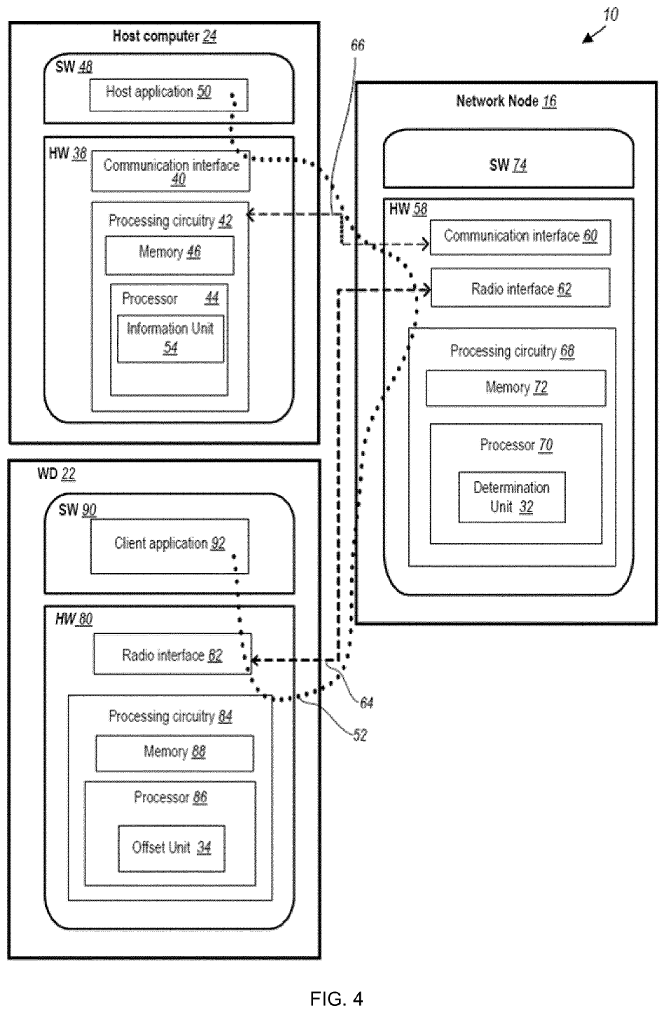

Example implementations, in accordance with an embodiment, of the WD 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein.

In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to one or more of providing, receiving, transmitting, determining and forwarding of information related to time offsets for allowing a wireless device to perform at least one power saving action.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include determination unit 32 configured to determine time offsets to allow a wireless device to perform at least one power saving action.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an offset unit 34 configured to implement time offsets for performing at least one power saving action.

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as determination unit 32, and offset unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

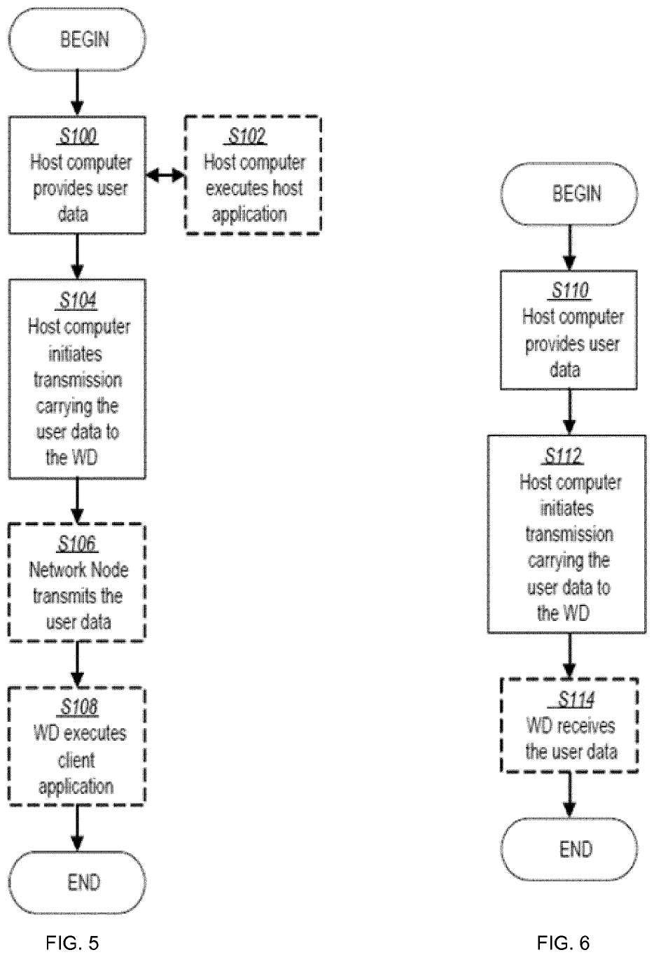

FIG. 5 is a flowchart illustrating an exemplary method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 114, associated with the host application 50 executed by the host computer 24 (Block S108).

FIG. 6 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

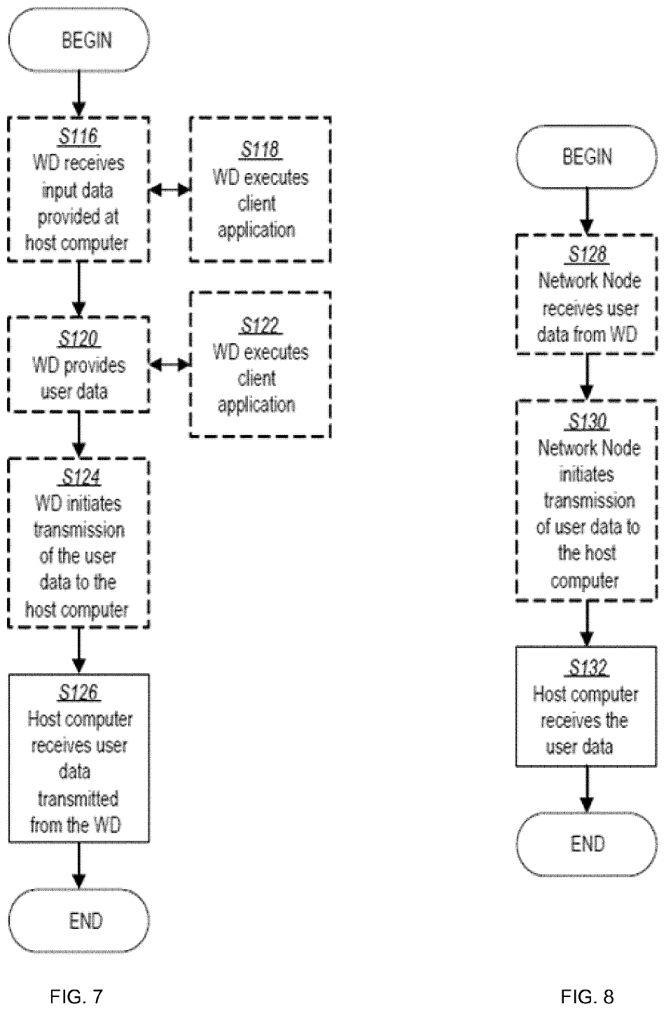

FIG. 7 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 114, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 114 (Block S122). In providing the user data, the executed client application 114 may further consider user input received from the user.

Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

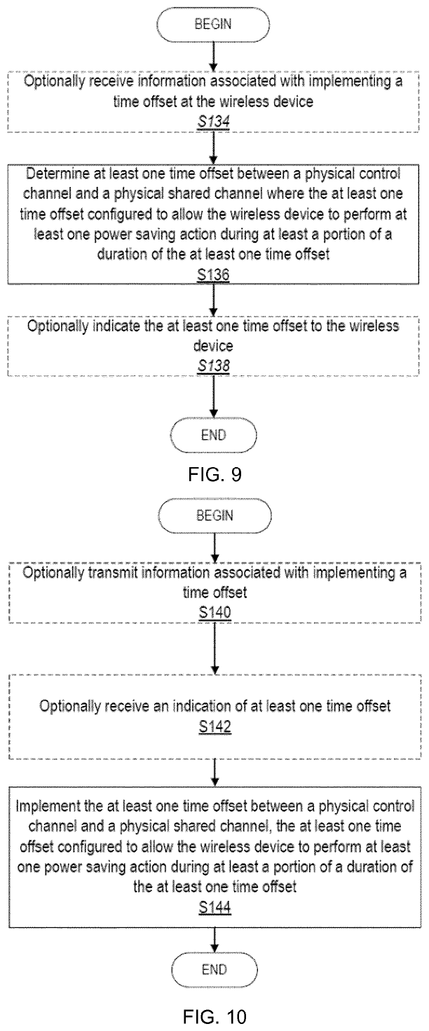

FIG. 9 is a flowchart of an exemplary process in a network node 16 in accordance with the principles of the disclosure. One or more Blocks and/or functions performed by network node 16 may be performed by one or more elements of network node 16 such as by determination unit 32 in processing circuitry 68, processor 70, radio interface 62, etc. In one embodiment, network node 16 such as via processing circuitry 68 and/or processor 70 and/or communication interface 60 and/or radio interface 62 is configured to optionally receive (Block S134) information associated with implementing a time offset at the wireless device 22. In one embodiment, network node 16 such as via processing circuitry 68 and/or processor 70 and/or communication interface 60 and/or radio interface 62 is configured to determine (Block S136) at least one time offset between a physical control channel and a physical shared channel where the at least one time offset configured to allow the wireless device 22 to perform at least one power saving action during at least a portion of a duration of the at least one time offset. In one embodiment, network node 16 such as via processing circuitry 68 and/or processor 70 and/or communication interface 60 and/or radio interface 62 is configured to optionally indicate (Block S138) the at least one time offset to the wireless device 22.

FIG. 10 is a flowchart of an exemplary process in a wireless device 22 according to some embodiments of the present disclosure in accordance with the principles of the disclosure. One or more Blocks and/or functions performed by wireless device 22 may be performed by one or more elements of wireless device 22 such as by offset unit 34 in processing circuitry 84, processor 86, radio interface 82, etc. In one embodiment, wireless device 22 such as via processing circuitry 84 and/or processor 86 and/or radio interface 82 is configured to optionally transmit (Block S140) information associated with implementing a time offset. In one embodiment, wireless device 22 such as via processing circuitry 84 and/or processor 86 and/or radio interface 82 is configured to optionally receive (Block S142) an indication of at least one time offset. In one embodiment, wireless device 22 such as via processing circuitry 84 and/or processor 86 and/or radio interface 82 is configured to implement (Block S144) the at least one time offset between a physical control channel and a physical shared channel, the at least one time offset configured to allow the wireless device to perform at least one power saving action during at least a portion of a duration of the at least one time offset

In one or more embodiments described herein, the information received at the network node 16 and/or transmitted by the wireless device 22 includes a capability of the wireless device 22 for implementing the at least one time offset or a requested time offset value. In one or more embodiments described herein, the at least one time offset is configured to be implemented every initial physical control channel in a series of physical control channel and physical shared channel operations. In one or more embodiments described herein, the indication is included in downlink control information or MAC control elements. In one or more embodiments described herein, the at least one time offset is a plurality of time offsets included in an offset mask corresponding to preconfigured time offsets.

Having generally described arrangements for determining and/or providing time offsets to allow a wireless device 22 to perform at least one power saving action, details for these arrangements, functions and processes are provided as follows, and which may be implemented by the network node 16, wireless device 22 and/or host computer 24. Embodiments described herein provide time offsets to allow a wireless device to perform at least one power saving action.

While the methods and examples herein focus on offset value K0, the teachings of the disclosure should not be construed as limiting the disclosure to K0 as the teachings and arrangements are applicable to other offsets such as the other offsets described herein. A few example methods are described as follows.

### Method 1:

In one or more embodiments, the wireless device 22 indicates to the network node 16 that it is beneficial for the wireless device 22 to be configured with higher offset values for certain or all BWPs and/or numerology. For example, the indication may include information associated with implementation and configuration of offset value. In one or more embodiments, this indication can either be explicitly coupled to the offsets, or a generic indication indicating, for example, that the wireless device 22 is a delay-tolerant wireless device, non-mission-critical, benefits-from-power-saving, etc. For example, the wireless device 22 could as part of its capability reporting (by, e.g., introducing new parameters in UECapabilityInformation) indicate that it is a delay tolerant type of wireless device 22. This way, the wireless device 22 would accept an initial delay for every first PDCCH in a series of PDCCH/PDSCH offsets (e.g., on-duration period of C-DRX) to improve its power efficiency.

Based on such indication (i.e., information), the network node 16 could, for example, as part of its offset configuration (part of RRC configuration in MSG4) exclude offsets imminent to PDCCH (e.g. K0=0) completely, i.e., determine time offsets to include/exclude or a time offset configuration for implementation by the wireless device 22.

In one or more embodiments, the network node 16 configuration could be extended to indicate back to the wireless device 22 that K0=0 (i.e., a predefined time offset value) may be excluded but only for a first PDCCH in a series of PDCCH/PDSCH operation (i.e., the wireless device 22 would implicitly know when K0=0 is applicable and when it is not applicable).

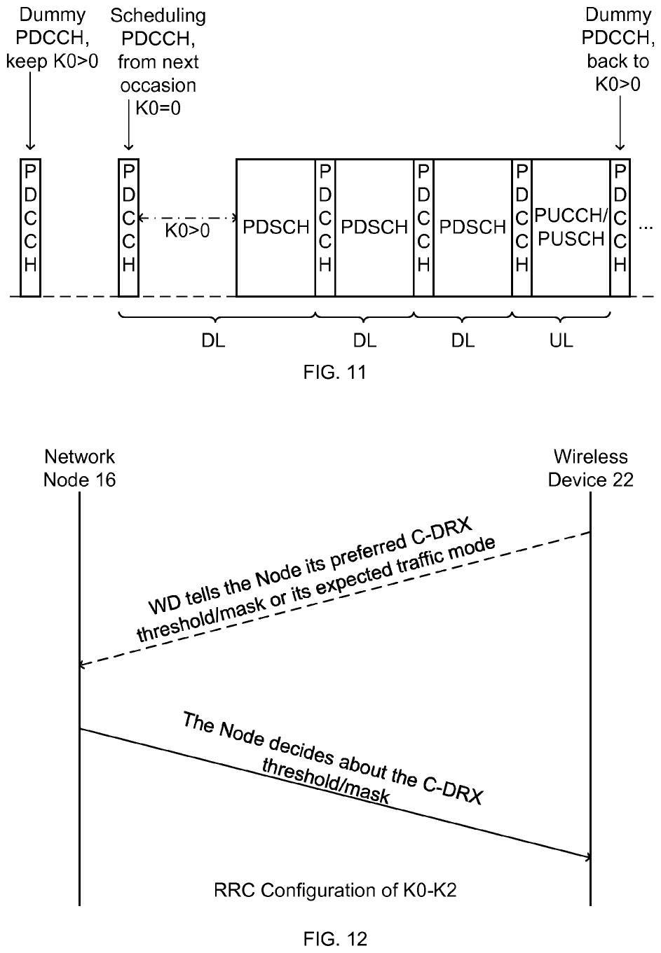

In one or more embodiments, the network node 16 could explicitly (de-)activate certain offsets via DCI or MAC control elements (MAC CE). For example, as shown in FIG. 11, the wireless device 22 can be configured to expect a K0>0 or the minimum time offset (i.e., minimum predefined time offset value) which may be required for the wireless device 22 to change the wireless device 22 operational mode between the PDCCH and PDSCH reception after waking up from DRX cycle. Therefore, the wireless device 22 can stay in the low power mode until a scheduling PDCCH is received. After the scheduling PDCCH is received, the network node 16 may keep using K0=0 until the wireless device 22 receives a dummy PDCCH which may signify, to the wireless device 22, the end of K0=0 and therefore the wireless device 22 may move to the default C-DRX operation mode. In one or more embodiments, the wireless device 22 also may not expect K1, K2 values equal to 0 after waking up from DRX cycle as well and until the wireless device 22 receives a scheduling PDCCH, otherwise the wireless device 22 remains in the low power mode until the next DRX cycle.

### Method 2:

In this method, the network node 16 determines and/or configures the wireless device 22 with a minimum offset threshold Thresh_{off} applicable to, e.g., C-DRX on-duration period, i.e., K0-K2, and aperiodicTriggeringOffset>Thresh_{off}. The offset threshold may be a timing offset threshold or predetermined value. The wireless device 22 then knows that offset values below Thresh_{off} may not be used unless the wireless device 22 configuration is updated through RRC. In one or more embodiments, the wireless device 22 knows that values below the threshold may not be used for the first transmission after a certain duration of inactivity, or in the first PDCCH reception during a CDRX or DRX on duration, but such values below the threshold may be used for subsequent transmissions.

In one or more embodiments, the wireless device 22 can inform the network node 16 of its preferred Thresh_{off}, potentially one for each BWP and/or numerology such as by transmitted information to the network node 16. However, the network node 16 may always be able to override this preferred offset threshold value and choose its own preferred Thresh_{off} for configuring the wireless device 22. Further, in one or more embodiments, the wireless device 22 can also inform the network node 16 of its expected traffic. For example, the wireless device 22 can inform the network node 16 that the wireless device 22 does not expect a mission critical message of extremely low latency and/or that the wireless device 22 is delay tolerant. This way, the network node 16 can consider this information when assigning the wireless device 22 with a longer threshold.

In one or more embodiments, the network node 16 configures the wireless device 22 such that the wireless device 22 does not expect offset values lower than Thresh_{off} for one or more radio interface operations, e.g., after the wireless device 22 wakes up from DRX cycle until the wireless device 22 receives a scheduling PDCCH. In other words, in one or more embodiments, the network node determines time offsets for implementation by the wireless device 22 and then configures the wireless device 22 according to the determination.

In one or more embodiments described herein, the value of Thresh_{off} can be different for one or more of the various offsets K0, K1, K2 and aperiodicTriggeringOffset.

### Method 3:

In this method, the network node 16 configures the wireless device 22 with an offset mask that informs the wireless device 22 that some specific values of the preconfigured offsets are not going to be used during, for example, C-DRX. For example, a normal K0 set is K0={0, 1, 2, 3, 4 . . . }. However, the network node 16 can produce an offset mask for K0 relevant to, for example, C-DRX on-duration period denoted by, e.g., m^{K0}={0,1,3}, or in binary format M^{K0}={1101000 . . . }, masking out the 0^{th}, 1^{st}, and 3^{rd} offset values (where “1” denotes a values to be masked). The wireless device 22 then knows that M^{K0} set of values may not be used for K0. Similar masks can be defined for the other offsets values either as a common mask applicable to several or all offsets or one mask per offset. Again, in one or more embodiments, the wireless device 22 knows the values excluded by the mask may not be used for the first transmission after a certain duration of inactivity, or in the first PDCCH reception during a C-DRX on duration, and that these excluded values may be used for subsequent transmissions.

In one or more embodiments, the wireless device 22 can inform the network node 16 of its preferred mask, however the network node 16 may always be able to override this preferred mask and choose a different preferred mask, if any, and configure the wireless device with the chosen preferred mask. In one or more embodiments, the wireless device 22 can also inform the network node 16 of its expected traffic such that the network node 16 consider this information when selecting/choosing the mask to be applied by the wireless device 22.

In one or more embodiments, the network node 16 configures the wireless device 22 such that the aforementioned mask may only be applicable to one or more radio interface operations such as after the wireless device 22 wakes up from a DRX cycle until it receives a scheduling PDCCH and/or specific BWPs with certain BW and/or numerology.

FIG. 12 is a signaling diagram for configuring the wireless device 22 with C-DRX threshold/mask in the second and third methods (Methods 2 and 3) described above. The dashed lines in FIG. 12 indicate an optional operation.

In one or more embodiments, a wireless device 22 and the network node 16 may not negotiate on the timing offsets, but rather the wireless device 22 may just ignore the undesirable offset values at certain occasions such as first PDCCH reception during C-DRX on-duration period. Compared to one or more embodiments incorporating “negotiation” between the network node 16 and the wireless device 22, this method may lead to an extra delay and waste of resource in case the network node 16 uses a small offset value (e.g. K0=0) as the resulting HARQ feedback, from the wireless device 22, may be NACK/DTX since the wireless device 22 missed a first PDSCH. The network node 16 could potentially be based on this repeated behavior from wireless device 22 side learn which values are desirable and not used them during those occasions. As used herein, “negotiations” may generally refer to the network node 16 and/or wireless device 22 providing and/or receiving information relating to timing offsets, where this information is described herein.

One or more advantages provided by the teachings of the disclosure include but are not limited to those provided as follows.

The one or more advantages provided by the teaching of the disclosure allow the wireless device 22 to influence the network node 16 to use offsets that are beneficial for the wireless device 22 in terms of power consumption. Based on network node 16/wireless device 22 interaction, the wireless device 22 would be able to decide about the change in operational modes such as numerology, power modes, etc.

The disclosure advantageously leverages the wireless device 22 to change the power modes from low to high and vice versa depending on the expected DL or UL operation, thereby improving the wireless device 22 power efficiency.

For example, the wireless device 22 usually expects a lower BW for PDCCH reception, and possibly a higher one for PDSCH. Therefore, in order to save energy, the wireless device 22 can potentially cause the BW between the PDCCH and PDSCH reception to change as described herein, instead of keeping the BW at the higher BW which can lead to higher power consumption. In another example, the wireless device 22 can completely turn off its RF reception chain, i.e., at least one radio chain, if the wireless device 22 is able to determine that no action is to be taken upon decoding the PDCCH. In both examples above, in order to do so, the wireless device 22 at least should be assured that offsets such as K0, and aperiodicTriggeringOffset are greater than 0, where this assurance can be provided to and/or determined by the wireless device 22 as described herein.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP 3^{rd} Generation Partnership Project
5G 5^{th} Generation
BB Baseband
BW Bandwidth
C-DRX Connected mode DRX (i.e. DRX in RRC_CONNECTED state)
CRC Cyclic Redundancy Check
DCI Downlink Control Information
DL Downlink
DRX Discontinuous Reception
gNB A radio base station in 5G/NR.
HARQ Hybrid Automatic Repeat Request
IoT Internet of Things
LO Local Oscillator
LTE Long Term Evolution
MAC Medium Access Control
MCS Modulation and Coding Scheme
mMTC massive MTC (referring to scenarios with ubiquitously deployed MTC devices)
ms millisecond
MTC Machine Type Communication
NB Narrowband
NB-IoT Narrowband Internet of Things
NR New Radio
NW Network
PDCCH Physical Downlink Control Channel
PDSCH Physical Downlink Shared Channel
RF Radio Frequency
RNTI Radio Network Temporary Identifier
RRC Radio Resource Control
RX Receiver/Reception
SSB Synchronization Signal Block
T/F Time/Frequency
TX Transmitter/Transmission
UE User Equipment
UL Uplink
WU Wake-up
WUG Wake-up Group
WUR Wake-up Radio/Wake-up Receiver
WUS Wake-up Signal/Wake-up Signaling

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

The disclosure may be summarized by the following Embodiments:

Embodiment A1. A network node configured to communicate with a wireless device (WD), the network node configured to, and/or comprising a radio interface and/or comprising processing circuitry configured to:

optionally receive information associated with implementing a time offset at the wireless device;
determine at least one time offset between a physical control channel and a physical shared channel, the at least one time offset configured to allow the wireless device to perform at least one power saving action during at least a portion of a duration of the at least one time offset; and
optionally indicate the at least one time offset to the wireless device.

Embodiment A2. The network node of Embodiment A1, wherein the received information includes a capability of the wireless device for implementing the at least one time offset or a requested time offset value.

Embodiment A3. The network node of Embodiment A1, wherein the at least one time offset is configured to be implemented every initial physical control channel in a series of physical control channel and physical shared channel operations.

Embodiment A4. The network node of Embodiment A1, wherein the indication is included in downlink control information or MAC control elements.

Embodiment A5. The network node of Embodiment A1, wherein the at least one time offset is a plurality of time offsets included in an offset mask corresponding to preconfigured time offsets.

Embodiment B1. A method implemented in a network node, the method comprising:
optionally receiving information associated with implementing a time offset at a wireless device;
   determining at least one time offset between a physical control channel and a physical shared channel, the at least one time offset configured to allow the wireless device to perform at least one power saving action during at least a portion of a duration of the at least one time offset; and
   optionally indicating the at least one time offset to the wireless device.

Embodiment B2. The method of Embodiment B1, wherein the received information includes a capability of the wireless device for implementing the at least one time offset or a requested time offset value.

Embodiment B3. The method of Embodiment B1, wherein the at least one time offset is configured to be implemented every initial physical control channel in a series of physical control channel and physical shared channel operations.

Embodiment B4. The method of Embodiment B1, wherein the indication is included in downlink control information or MAC control elements.

Embodiment B5. The method of Embodiment B1, wherein the at least one time offset is a plurality of time offsets included in an offset mask corresponding to preconfigured time offsets.

Embodiment C1. A wireless device (WD) configured to communicate with a network node, the WD configured to, and/or comprising a radio interface and/or processing circuitry configured to:

optionally transmit information associated with implementing a time offset;
optionally receive an indication of at least one time offset; and
implement the at least one time offset between a physical control channel and a physical shared channel, the at least one time offset configured to allow the wireless device to perform at least one power saving action during at least a portion of a duration of the at least one time offset.

Embodiment C2. The WD of Embodiment C1, wherein the transmitted information includes a capability of the wireless device for implementing the at least one time offset or a requested time offset value.

Embodiment C3. The WD of Embodiment C1, wherein the at least one time offset is configured to be implemented every initial physical control channel in a series of physical control channel and physical shared channel operations.

Embodiment C4. The WD of Embodiment C1, wherein the indication is included in downlink control information or MAC control elements.

Embodiment C5. The WD of Embodiment C1, wherein the at least one time offset is a plurality of time offsets included in an offset mask corresponding to preconfigured time offsets.

Embodiment D1. A method implemented in a wireless device (WD), the method comprising:

optionally transmitting information associated with implementing a time offset;
optionally receiving an indication of at least one time offset; and
implementing the at least one time offset between a physical control channel and a physical shared channel, the at least one time offset configured to allow the wireless device to perform at least one power saving action during at least a portion of a duration of the at least one time offset.

Embodiment D2. The method of Embodiment D1, wherein the transmitted information includes a capability of the wireless device for implementing the at least one time offset or a requested time offset value.

Embodiment D3. The method of Embodiment D1, wherein the at least one time offset is configured to be implemented every initial physical control channel in a series of physical control channel and physical shared channel operations.

Embodiment D4. The method of Embodiment D1, wherein the indication is included in downlink control information or MAC control elements.

Embodiment D5. The method of Embodiment D1, wherein the at least one time offset is a plurality of time offsets included in an offset mask corresponding to preconfigured time offsets.

1. A network node configured to communicate with a wireless device, the network node comprises a radio interface and processing circuitry, and is configured to:
determine information associated with implementing a time offset at the wireless device;
determine at least one time offset between a physical control channel and a physical shared channel; and
indicate the at least one time offset to the wireless device.

2. The network node of claim 1, wherein determination of the information associated with implementing a time offset in the wireless device comprises reception of the information from the wireless device.

3. The network node of claim 2, wherein the received information includes a capability of the wireless device for implementing one of the at least one time offset and a requested time offset value.

4. The network node of claim 1, wherein the determination of the information associated with implementing a time offset in the wireless device comprises acquisition of the information from another network node.

5. The network node of claim 1, wherein the at least one time offset is configured to be implemented for every initial physical control channel operation in a series of physical control channel and physical shared channel operations.

6. The network node of claim 1, wherein an indication of the at least one time offset is included in downlink control information or Medium Access Control signal elements.

7. The network node of claim 1, wherein the at least one time offset is a plurality of time offsets included in an offset mask corresponding to preconfigured time offsets.

8. The network node of claim 1, wherein to indicate the at least one time offset to the wireless device comprises a transmission of the at least one time offset.

9. The network node of claim 1, wherein the network node is configured to receive a determined minimum offset for per bandwidth part or numerology from the wireless device.

10. The network node of claim 1, wherein the network node is configured to transmit a configured minimum offset for per bandwidth part or numerology to the wireless device.

11. The network node of claim 1, wherein the network node is configured to transmit an indication to the wireless device whether a predefined offset value is applicable or not.

12. The network node of claim 11, wherein the indication is transmitted as a DCI or MAC control element.

13. The network node of claim 1, arranged wherein the network node is configured to transmit an offset mask to the wireless device, wherein the offset mask indicates offset values which are to be excluded.

14. The network node of claim 1, wherein the network node is configured to receive information about expected traffic from the wireless device and select applicable offset values based on the received information.

15. The network node of claim 1, wherein the at least one time offset is configured to allow the wireless device to perform at least one power saving action during at least a portion of a duration of the at least one time offset.

16. A method implemented in a network node, the method comprising:
determining information associated with implementing a time offset at a wireless device;
determining at least one time offset between a physical control channel and a physical shared channel; and
indicating the at least one time offset to the wireless device.

17. The method of claim 16, wherein determining of the information associated with implementing a time offset in the wireless device comprises receiving the information from the wireless device.

18. The method of claim 17, wherein the received information includes a capability of the wireless device for implementing one of the at least one time offset and a requested time offset value.

19. The network node of claim 16, wherein the determination of the information associated with implementing a time offset in the wireless device comprises acquiring the information from another network node.

20. The method of claim 16, wherein the at least one time offset is configured to be implemented for every initial physical control channel operation in a series of physical control channel and physical shared channel operations.

21. The method of claim 16, wherein an indication of the at least one time offset is included in one of a downlink control information and Medium Access Control signal elements.

22. The method of claim 16, wherein the at least one time offset is a plurality of time offsets included in an offset mask corresponding to preconfigured time offsets.

23. The method of claim 16, wherein the indicating of the at least one time offset to the wireless device comprises transmitting information about the at least one time offset.

24. The method of claim 16, comprising receiving a determined minimum offset for per bandwidth part or numerology from the wireless device.

25. The method of claim 16, comprising transmitting a configured minimum offset for per bandwidth part or numerology to the wireless device.

26. The method of claim 16, comprising transmitting an indication to the wireless device whether a predefined offset value is applicable.

27. The method of claim 26, wherein the indication is transmitted as a DCI or MAC control element.

28. The method of claim 16, comprising transmitting an offset mask to the wireless device, wherein the offset mask indicates offset values which are to be excluded.

29. The method of claim 16, comprising:
receiving information about expected traffic from the wireless device; and
selecting applicable offset values based on the received information.

30. The method of claim 16, wherein the at least one time offset is configured to allow the wireless device to perform at least one power saving action during at least a portion of a duration of the at least one time offset.

31. A wireless device, WD, configured to communicate with a network node, the WD comprises a radio interface and processing circuitry and is configured to:
receive an indication of at least one time offset; and
configure the receiver according to an assumption of the at least one time offset between a physical control channel and a physical shared channel, wherein the at least one time offset is configured to allow the wireless device to perform at least one power saving action during at least a portion of a duration of the at least one time offset.

32. The WD of claim 30, configured to transmit information associated with implementing a time offset to the network node.

33. The WD of claim 32, wherein the transmitted information includes a capability of the wireless device for implementing one of the at least one time offset and a requested time offset value.

34. The WD of claim 31, wherein the information associated with implementing a time offset has been made available to another network node.

35. The WD of claim 31, wherein the at least one time offset is configured to be implemented for every initial physical control channel operation in a series of physical control channel and physical shared channel operations.

36. The WD of claim 31, wherein the indication is included in one of a downlink control information and Medium Access Control signal elements.

37. The WD of claim 31, wherein the at least one time offset is a plurality of time offsets included in an offset mask corresponding to preconfigured time offsets.

38. The WD of claim 31, wherein the WD is configured to transmit a determined minimum offset for per bandwidth part or numerology.

39. The WD of claim 31, wherein the WD is configured to receive, from a network node, a configured minimum offset for one of per bandwidth part and numerology.

40. The WD of claim 31, arranged to receive an indication from a network node whether a predefined offset value is applicable not.

41. The WD of claim 40, wherein the indication is conveyed in one of a DCI and MAC control element.

42. The WD of claim 31, wherein the WD is configured to receive an offset mask from a network node, wherein the offset mask indicates offset values which are to be excluded.

43. The WD of claim 31, wherein the WD is configured to transmit information about expected traffic to a network node for the network node to select applicable offset values based on the information.

44. A method implemented in a wireless device, WD, the method comprising:
receiving an indication of at least one time offset; and
configuring the receiver according to an assumption of the at least one time offset between a physical control channel and a physical shared channel, wherein the at least one time offset is configured to allow the wireless device to perform at least one power saving action during at least a portion of a duration of the at least one time offset.

45. The method of claim 44, comprising transmitting information associated with implementing a time offset.

46. The method of claim 45, wherein the transmitted information includes a capability of the wireless device for implementing one of the at least one time offset and a requested time offset value.

47. The method of claim 44, wherein the at least one time offset is configured to be implemented for every initial physical control channel operation in a series of physical control channel and physical shared channel operations.

48. The method of claim 44, wherein the indication is included in one of downlink control information and Medium Access Control signal elements.

49. The method of claim 44, wherein the at least one time offset is a plurality of time offsets included in an offset mask corresponding to preconfigured time offsets.

50. The method of claim 44, comprising transmitting a determined minimum offset for one of per bandwidth part and numerology.

51. The method of claim 44, comprising receiving from a network node a configured minimum offset for one of per bandwidth part and numerology.

52. The method of claim 44, comprising receiving an indication from a network node whether a predefined offset value is applicable.

53. The method of claim 50, wherein the indication is conveyed in a DCI or MAC control element.

54. The method of claim 42, comprising receiving an offset mask from a network node, wherein the offset mask indicates offset values which are to be excluded.

55. The method of claim 42, comprising:
transmitting information about expected traffic to a network node for the network node to select applicable offset values based on the information.
